(19) United States
(12) Patent Application Publication
(10) Pub. No.: US 2026/0008724 A1
(43) Pub. Date: Jan. 8, 2026

(54) METHOD FOR THE PRODUCTION OF WET CONCRETE APPLICABLE TO THE FABRICATION OF STRUCTURAL EXTERIOR ELEMENTS OR STRUCTURAL INTERIOR ELEMENTS

(71) Applicant: Trifami 3D Oy, Hämeenlinna (FI)

(72) Inventors: Timo SOLLO, Hämeenlinna (FI); Reetta-Maria TOLONEN-SALO, Hämeenlinna (FI)

(21) Appl. No.: 19/112,406

(22) PCT Filed: Sep. 15, 2023
(86) PCT No.: PCT/FI2023/050526

§ 371 Date: Mar. 17, 2025

(30) Foreign Application Priority Data
Sep. 16, 2022 (FI) 20225807

(51) Int. Cl. C04B 18/167; C04B 20/02; C04B 28/02; C04B 103/30; E04G 21/02

(52) U.S. Cl. CPC C04B 18/167; C04B 20/026; C04B 28/02; E04G 21/02; C04B 2103/30; C04B 2201/50

(57) ABSTRACT

The invention relates to a method for the production of concrete applicable to the fabrication of structural exterior components or structural interior components, by mixing a binder, especially cement, a filler, comprising reclaimed aggregate, and water, as well as possible admixtures, such as a plasticizer, in such a way that the dry matter of wet concrete comprises a binder, especially cement, 10-40% by weight, preferably 25-30% by weight, a filler, especially aggregate, 90-60% by weight, the total amount of filler (i.e. aggregate) being nevertheless not more than 80% by weight of the wet concrete's total weight, and said aggregate comprising reclaimed aggregate, such as crushed concrete, 10-90% by weight, preferably 30-60% by weight, and other aggregate, such as sand or crushed stone, 90-10% by weight, preferably 70-40% by weight.

The invention relates to a method as defined in the preamble of claim 1 for the production of wet concrete applicable to the fabrication of structural exterior elements.

The invention relates also to a method as defined in the preamble of claim 2 for the production of wet concrete applicable to the fabrication of structural interior elements.

At present, there are hardly any prior known uses for demolition concrete other than in earth construction.

Demolition companies strive to deliver the crushed concrete, obtained from concrete waste and consisting of demolition concrete, directly from a demolition site to a utilization project, i.e. to earth construction, which at the moment is the most sensible usage of demolition concrete in terms of economy and environment. Concrete waste, and crushed concrete obtained therefrom, may also be delivered to recycling facilities for processing, but that increases costs incurred by concrete waste treatment and, therefore, is not the most sensible option economically, let alone in terms of the environment.

From the ecological standpoint, however, it would be desirable that demolition concrete consisting of concrete waste, and crushed concrete obtained therefrom, could find applications other than just in relation to earth construction, one being for example the reuse of demolition concrete-derived crushed concrete in house construction; more and more commercial buildings or residential buildings are being demolished instead of being renovated, both in Finland and abroad. The use of demolition concrete at a construction site would represent sensible reuse.

Structures to be demolished, such as apartment buildings, manufacturing plants, bridges, concrete floors in industrial halls, and the like structures, are nevertheless difficult to make use of as a result of hazardous materials, such as halogen compounds contained in these structures, or foreign substances, such as wool, gypsum, tiles, pieces of wire, glass, etc., present in concrete.

Concrete industry produces also a significant amount of surplus concrete such as surplus concrete elements and other such structures, also with the possible presence of hazardous substances and foreign materials.

The use of demolition concrete-derived crushed concrete for producing wet concrete applicable to house construction is prevented, among others, by the fact that house construction involves considerably stringent quality requirements, especially in terms of concrete to be used in the interior spaces of buildings.

These quality requirements also apply to demolition concrete-derived crushed concrete, from which the concrete used in a building's interior is produced, as regards, among others, foreign substances, and it is often that ending up within the concrete waste are many other waste fractions, such as wool, gypsum, tiles, pieces of wire, etc.

In this disclosure, concrete waste, as well as surplus concrete, refers to a concrete structure, which intended to be demolished/destructed into crushed concrete. The concrete structure is for example a concrete floor, a concrete element.

Demolition concrete refers to coarse crushed concrete, as well as to concrete blocks, obtained from concrete waste or surplus concrete in demolition process.

In addition, the wet concrete to be used for house construction, and hence also the binder and aggregate to be used for producing wet concrete, are required to possess appropriate construction engineering properties, such as appropriate strength requirements.

With the foregoing prior art as a starting point, it is an objective of the present invention to eliminate or at least to alleviate problems occurring in the foregoing prior art and to provide a method of producing, from demolition concrete, such crushed concrete from which it would be possible to make wet concrete applicable to concrete industry.

The invention indeed relates to a method defined in claim 1 for the production of wet concrete applicable to the fabrication of structural exterior components.

The invention also relates to a method defined in claim 2 for the production of wet concrete applicable to the fabrication of structural interior components.

More specifically, the invention relates to a method for the production of wet concrete applicable to the fabrication of structural exterior components, by mixing a binder, especially cement, a filler, comprising reclaimed aggregate, and water, as well as possible admixtures, such as a plasticizer, in such a way that from the dry matter of wet concrete the portion of a binder, especially cement, is 10-40% by weight, preferably 25-30% by weight, the portion of a filler, especially aggregate, is 90-60% by weight, the total amount of filler (i.e. aggregate) being nevertheless not more than 80% by weight of the wet concrete's total weight, and said aggregate comprising reclaimed aggregate, especially cleaned crushed concrete, 10-100% by weight, preferably 30-60% by weight, and other aggregate, such as sand or crushed stone, 90-0% by weight, preferably 70-40% by weight.

The production of reclaimed aggregate, especially cleaned crushed concrete, comprises the following method steps A-D of.
A) producing cleaned crushed concrete by removing from a concrete structure made up of surplus concrete or concrete waste, or from demolition concrete, especially coarse crushed concrete, obtained therefrom, hazardous materials as well as foreign substances in such a way that the presence of foreign substances and/or hazardous materials in the cleaned crushed concrete is such that, as for foreign substances, the portion of floating particles (FL) is not more than 5 cm³/kg of crushed concrete, such as 0-5 cm³/kg of crushed concrete, preferably 0 cm³/kg of crushed concrete, the content of non-floating material, comprising foreign matter, in the crushed concrete is not more than 1% by weight, such as 0-1% by weight, especially 0% by weight, and the amount of brick and tile waste (Rb), comprising foreign matter, is less than 30% by weight, preferably less than 10% by weight, such as 0-10% by weight, especially 0-2% by weight, particularly favorably 0% by weight, and the amount of hazardous materials per kg of cleaned crushed concrete is as follows: the amount of polychlorinated phenyls is not more than 1 mg/kg, the amount of polyaromatic hydrocarbons is not more than 30 mg/kg, and the amount of mineral oils (C₁₀-C₄₀) is not more than 200 mg/kg;
B) evaluating or determining a target strength for cleaned crushed concrete into one of the classes (1-3) in order to produce cleaned and strength-graded crushed concrete:
   strength class 1, cleaned crushed concrete, structural target strength not more than 45 N/mm²,
   strength class 2, cleaned crushed concrete, structural target strength not more than 45 N/mm², yet more than 30 N/mm²,
   strength class 3, cleaned crushed concrete, no structural target strength;
C) crushing the cleaned and strength-graded crushed concrete into finer particles with a crushing device, followed by screening the finely crushed concrete with a sieving device for producing cleaned, finely crushed and screened crushed concrete, which is included in one of the sieve classes C1-C4;
   class C1, cleaned, strength-graded, finely crushed and screened crushed concrete, particle size more than 32 mm,
   class C2, cleaned, strength-graded, finely crushed and screened crushed concrete, particle size 16-32 mm,
   class C3, cleaned, strength-graded, finely crushed and screened crushed concrete, particle size 8-16 mm,
   class C4, cleaned, strength-graded, finely crushed and screened crushed concrete, particle size 0-8 mm;
D) selecting, for reclaimed aggregate in wet concrete, cleaned, strength-graded, finely crushed and screened crushed concrete, comprising crushed concrete in strength class 1, 2 or 3 and having a particle size in one of the classes C1-C4.

The invention relates also to a method for the production of wet concrete applicable to the fabrication of structural interior components, by mixing a binder, especially cement, a filler, comprising reclaimed aggregate, and water, as well as possible admixtures, such as a plasticizer, in such a way that from the dry matter of wet concrete the portion of a binder, especially cement, is 10-40% by weight, preferably 25-30% by weight, the portion of a filler, especially aggregate, is 90-60% by weight, the total amount of filler (i.e. aggregate) being nevertheless not more than 80% by weight of the wet concrete's total weight, and said aggregate comprising reclaimed aggregate, especially cleaned crushed concrete, 10-100% by weight, preferably 30-60% by weight, and other aggregate, such as sand or crushed stone, 90-0% by weight, preferably 70-40% by weight.

In the method, the production of reclaimed aggregate comprises method steps A-D of:
A) producing cleaned crushed concrete by removing from a concrete structure made up of surplus concrete or concrete waste, or from demolition concrete, especially coarse crushed concrete, obtained from a concrete structure, hazardous materials as well as foreign substances and, if necessary, by crushing a concrete structure or demolition concrete obtained therefrom into finer crushed concrete in such a way that the cleaned crushed concrete has foreign substances and/or hazardous materials present therein and, as for said foreign substances, the portion of floating particles (FL) is not more than 5 cm³/kg of crushed concrete, such as 0-5 cm³/kg of crushed concrete, preferably 0 cm³/kg of crushed concrete, the content of non-floating material, comprising foreign matter, in the crushed concrete is not more than 1% by weight, such as 0-1% by weight, especially 0% by weight, and the portion of brick and tile waste (Rb), included in foreign substances, is less than 30% by weight, preferably less than 10% by weight, such as 0-10% by weight, especially 0-2% by weight, particularly favorably 0% by weight per kg of crushed concrete, and the amount of hazardous materials, particularly polychlorinated phenyls, per kg of crushed concrete is not more than 1 mg/kg, the amount of polyaromatic hydrocarbons is not more than 30 mg/kg of crushed concrete, and the amount of mineral oils (C₁₀-C₄₀) is not more than 200 mg/kg of crushed concrete,
B) evaluating or determining a target strength (compressive strength) for cleaned crushed concrete into one of the classes (1-3) in order to produce clean and strength-graded crushed concrete:
   strength class 1, crushed concrete, structural target strength not more than 45 N/mm²,
   strength class 2, crushed concrete, structural target strength not more than 45 N/mm², yet more than 30 N/mm²,
   strength class 3, crushed concrete, no structural target strength;
C) crushing the cleaned and strength-graded crushed concrete, if necessary, into finer particles with a crushing device, followed by screening the finely crushed concrete with a sieving device for producing clean, finely crushed and screened crushed concrete, which is included in one of the sieve classes C1-C4;
   class C1, cleaned, strength-graded, finely crushed and screened crushed concrete, particle size more than 32 mm,
   class C2, cleaned, strength-graded, finely crushed and screened crushed concrete, particle size 16-32 mm,
   class C3, cleaned, strngth-graded, finely crushed and screened crushed concrete, particle size 8-16 mm,
   class C4, cleaned, strength-graded, finely crushed and screened crushed concrete, particle size 0-8 mm;
D) selecting, for reclaimed aggregate in wet concrete, cleaned, strength-graded, finely crushed and screened crushed concrete, comprising crushed concrete in strength class 1 or 2 and having a particle size in class C2 or C3.

It is the basis of the invention that, in the production of wet concrete which is applicable to the fabrication of structural exterior components or structural interior components used in the construction of concrete structures from crushed concrete based on demolition concrete, attention is paid to both strength and purity requirements of wet concrete. Attention is further paid also to construction engineering regulations regarding wet concrete, especially strength regulations, which, in the construction of concrete structures, the fabrication of structural exterior components or structural interior components are required of concrete and its mixing ingredients. As for hazardous materials, especially the amount of polychlorinated phenyls is held in the invention to not more than 1 mg/kg of crushed concrete, the amount of polyaromatic hydrocarbons is held to not more than 30 mg/kg of crushed concrete, and the amount of mineral oils (C₁₀-C₄₀) is held to not more than 200 mg/kg of crushed concrete.

As for the benefits of the invention, it should be further noted that the treatment of hazardous and foreign materials becomes more environmentally friendly with improved sorting.

The structural exterior component stands for individual pieces of concrete, as well as for parts and components produced from concrete, which are employed in the fabrication of concrete structures intended for outdoor use or for the fabrication of concrete structures, i.e. concrete structures which, as a rule, are not in contact with a building's indoor air.

The structural interior component, on the other hand, stands for individual pieces of concrete, as well as for parts and components produced from concrete, which are employed for the fabrication of concrete structures intended for indoor use i.e. for the fabrication of concrete structures which are in contact with a building's indoor air.

The concrete structure refers to an individual structure made up of concrete, or to a part of a building or construction, such as a foundation, stairs, a floor, a ceiling or a floor constructed from concrete.

Recycled crushed concrete is classified into one of the strength classes 1, 2 or 3 in the case of making structural exterior components and into strength class 1 or 2 in the case of making structural interior components.

In the selection of crushed concrete, attention is further paid to the requirements imposed on wet concrete by structural exterior components and structural interior components: 3D printing in the fabrication of structural interior components is preferably conducted by using wet concrete with relatively low moisture content.

Hazardous materials refer here to organic and inorganic hazardous substances not included in concrete material.

What is perceived by concrete or concrete material is a hard, stonelike material used for construction purposes, typically consisting of a filler, cement, water, and possible admixtures. The filler comprises typically a hard, chemically unreactive material, such as stone or sand, comprising various particle sizes. Cement comprises typically limestone, clay, and gypsum. Cement reacts with water in such a way that the cement hardens and, upon hardening, binds the maturing concrete together. The properties of maturing concrete can be modified by changing the mixing ratios and the filler's particle size distribution as well as, for example, by supplementing the concrete mix with admixures, such as plasticizers, a hardening accelerator (e.g. calcium formate, triethanolamine, finely divided silica, etc.), a concrete hardening retarder, a deaeration promoter, a corrosion inhibitor, a microbicidal additive, water absorption inhibitors. With regard to the more specific composition and amount of admixtures, reference is made to the compositions and usagesof additives commonly known to a person skilled in the art and employed in concrete production, and to prior art technology, such as the industry standards and publications (e.g. the BY publications of Betoniteollisuus (Concrete Industry) ry, as well as ASTM C0494/C494M-17).

Typically, concrete comprises cement about 10-30% by weight, a filler 50-80% by weight, water 5-20% by weight, and possible admixtures about 0.5-3% by weight.

The most important ingredients for cement are iron sulfate, fly ash, gypsum, nickel grain and copper slag, blast furnace slag, limestone and silica. Admixtures for cement also often contain non-metallic and metallic compounds considered as hazardous materials, the concentrations of which must be held within acceptable limits when concrete produced from such cement is used as reclaimed aggregate.

The design of concrete structures proceeds generally along the lines of Eurocodes EN 1990-1992 and materials of concrete are mainly CE marked and each has its designated European standard. From these standards are further derived limit values for the quality and usage of the materials (cement and cement mixture ingredients, concrete admixtures and aggregate).

In the invention, from the surplus concrete of concrete industry or demolished concrete (concrete blocks and coarse crushed concrete) are removed not only foreign substances but also hazardous materials. The hazardous materials are generally removed prior to crushing the surplus concrete or concrete waste into cleaned crushed concrete.

One embodiment of the invention involves analyzing or assessing first the hazardous materials and foreign substances present in surplus concrete or concrete waste used for producing cleaned crushed concrete (hazardous materials analysis). It is after the removal of foreign substances and the removal/reduction of hazardous materials that the surplus concrete or concrete waste is processed into cleaned crushed concrete.

A hazardous materials analysis (hazardous materials survey) is conducted on a to-be-demolished concrete structure of concrete waste prior to its demolition during its material review. The Ministry of the Environment has on Nov. 15, 2019 published a pre-demolition audit guide (Demolition survey—guide for the auditor), which provides information about the best practices for assessing construction and demolition waste flows, i.e. for a pre-demolition survey, to be conducted prior to the demolition or renovation of a building or structure.

In another embodiment for a method of the invention, the surplus concrete or concrete waste is processed into coarse crushed concrete. The crushed concrete is analyzed and the foreign substances, and possibly also some hazardous materials, are removed therefrom in order to produce cleaned crushed concrete.

As pointed out above, with regard to organic hazardous materials, the acceptable amount of polychlorinated phenyls in cleaned crushed concrete is not more than 1 mg/kg, the acceptable amount of polyaromatic hydrocarbons in cleaned crushed concrete is not more than 30 mg/kg, and the acceptable amount of mineral oils (C₁₀-C₄₀) in cleaned crushed concrete is not more than 200 mg/kg.

Polychlorinated phenyls, i.e. PCB compounds, refer to chlorinated biphenyl products. The general formula of PCB compounds is C₁₂H₁₀₋ₓClₓ, wherein x stands for the number (integer) of chlorine atoms, which is within the range of 1-10. The amount of polychlorinated phenyls in crushed concrete is not allowed to be more than 1 mg/kg of crushed concrete.

The presence and amount of PCB compounds can be analyzed from concrete waste or surplus concrete, or from demolition concrete or crushed concrete obtained therefrom, with the method presented in standard SFS EN 17322:2020.

Polyaromatic hydrocarbons (PAH) refer to polycyclic aromatic hydrocarbons. These are organic compounds, comprising several fused aromatic rings and having no heteroatoms on the ring. Examples of polyaromatic hydrocarbons include naphthalene, anthracene, phenanthrene, chrysene, benzo[a]pyrene, benzo[e]pyrene, benzo[b]fluoranthene, etc.

The amount of polyaromatic hydrocarbons allowed in crushed concrete is not more than 30 mg/kg of crushed concrete. The presence and amount of polyaromatic hydrocarbons can be analyzed from concrete waste or surplus concrete, or from demolition concrete obtained therefrom, especially from crushed concrete, with the method presented in standard EN 17322:2020.

The presence of polyaromatic hydrocarbons (PAH compounds) in a concrete material can be determined with an appropriate determination method, such as in accordance with standard SFS-EN 15527:2022 or SFS-ISO 18287:2006.

Mineral oils (C₁₀-C₄₀) refer to petroleum hydrocarbons, wherein the carbon chain has a length of 10-40 carbon atoms (C10-C40). Mineral oil is an oil refined by distillation from crude oil.

The amount of mineral oils (C₁₀-C₄₀) allowed in crushed concrete is not more than 200 mg/kg of crushed concrete, such as 1-200 mg/kg of crushed concrete.

The presence and amount of mineral oils in concrete waste or surplus concrete, or in demolition concrete, such as crushed concrete, obtained therefrom, can be determined with the method defined by standard EN 14039:2004.

Mineral oils (C₁₀-C₄₀), among others, find their way into concrete waste (e.g. a concrete floor to be demolished) generally during use or along with surface materials. Hence, the discussed organic hazardous materials remain usually in the surface layer of a concrete structure and can be removed therefrom, if necessary, by grinding or shot blasting.

In one preferred embodiment of the invention, the cleaned crushed concrete is allowed to contain fluoride compounds (F) not more than 12 mg/kg, sulfate ions (SO₄²⁻) not more than 300 mg/kg, and chloride ions (Cl) not more than 200 mg/kg.

In one preferred embodiment of the invention, the cleaned crushed concrete is allowed to contain hazardous substances as selected from among fluoride ions (F) not more than 12 mg/kg, such as 0.1-12 mg/kg, sulfate ions (SO₄²⁻) not more than 300 mg/kg, such as 1-300 mg/kg, and chloride ions (Cl) not more than 200 mg/kg, such as 1-200 mg/kg.

These hazardous materials find their way into surplus concrete or concrete waste, or into demolished concrete obtained therefrom during demolition, often along with a concrete binder, especially cement (e.g. chlorine compounds), whereby the removal thereof from concrete cannot generally be achieved except by separating contaminated concrete waste or surplus concrete, or contaminated demolition concrete, such as crushed concrete, obtained therefrom, away from the clean concrete material.

Alternatively, it is possible to employ a so-called HAS classification technology (Heating Air Classification System), based on the use of hot air (600° C.), for removing the hazardous substances of concrete, and especially those of cement, from demolished concrete. In HAS technology, the concrete waste recycling is conducted by heating the concrete in combination with the sorting of crushed concrete at high temperature, the process time being 25-40 s. The HAS classification technology has been described e.g. in article Moreno-Juez et al.; Journal of Cleaner Production, Vol 263,1 Aug. 2020, 121515.

The presence and amount of these hazardous materials, containing halogen compounds, in a concrete structure, or in crushed concrete obtained therefrom, can be measured with a percolation test std CEN/TS 14405:2004 or with a batch test std SFS-EN-12457-3:2012 or with a method as defined in technical report CEN/TR 16192:2020.

In one preferred embodiment of the invention, the cleaned crushed concrete may contain, per kilogram of crushed concrete (presented as the soluble total amount of each hazardous substance per kilogram of crushed concrete), antimony (Sb) not more than 0.2 mg/kg, such as 0.001-0.2 mg/kg, arsenic (As) not more than 0.1 mg/kg, such as 0.001-0.1 mg/kg, barium (Ba) not more than 5 mg/kg, such as 0.01-5 mg/kg, cadmium (Cd) not more than 0.02 mg/kg, such as 0.0001-0.02 mg/kg, chromium (Cr) not more than 0.6 mg/kg, such as 0.001-0.6 mg/kg, copper (Cu) not more than 1 mg/kg, such as 0.01-1 mg/kg, mercury (Hg) not more than 0.01 mg/kg, such as 0.0001-0.01 mg/kg, lead (Pb) not more than 0.1 mg/kg, such as 0.001-0.1 mg/kg, molybdenum (Mo) not more than 0.7 mg/kg, such as 0.001-0.7 mg/kg, nickel (Ni) not more than 0.3 mg/kg, such as 0.001-0.3 mg/kg, vanadium (V) not more than 0.3 mg/kg, such as 0.001-0.3 mg/kg, zinc (Zn) not more than 4 mg/kg, such as 0.01-4 mg/kg, selenium (Se) not more than 0.2 mg/kg, such as 0.001-0.2 mg/kg, fluorides (F⁻) not more than 12 mg/kg, such as 0.01-12 mg/kg, sulfates (SO₄²⁻) not more than 300 mg/kg, such as 1-300 mg/kg, and chlorides (Cl) not more than 200 mg/kg, such as 1-200 mg/kg.

Several of the discussed hazardous materials find their way into concrete structures by way of various coatings such as paints (lead, zinc, among others). These hazardous materials often remain in the surface layer of concrete and can be removed therefrom, as necessary, by grinding or shot blasting.

According to the Ministry of Environment's publication 2019:30 (Demolition survey—Guide the auditor), the recommendation for the survey and review of hazardous materials is to use the instruction RT 18-11245 Haitta-ainetutkimus. Rakennustuotteet ja rakenteet (Survey of hazardous materials. Building products and structures) published by Rakennustietosäätiö RTS ry (Construction Information Foundation) and Rakennustieto Oy (Construction Information Ltd.).

The amount of heavy metals, non-metals, and metalloids in surplus concrete or concrete waste, or in demolition concrete obtained therefrom, can be determined with the method presented in standard technical report CEN/TR 16192:2020. The amount of mineral oils in surplus concrete or concrete waste, or in demolition concrete obtained therefrom, can be determined with the method set forth in standard SFS-EN 14039:2014. The amount of polychlorinated hydrocarbons (PCB) in surplus concrete or concrete waste, or in demolition concrete obtained therefrom, can be determined with the method presented in standard SFS-EN 17322:2020. The amount of polyaromatic hydrocarbons (PAH) in surplus concrete or concrete waste, or in demolition concrete obtained therefrom, can be determined with the method presented in standard SFS-EN 15527:2022 or SFS-ISO 18287:2006. The material distribution, the amount of impurities and floating impurities in surplus concrete or concrete waste, or in demolition concrete obtained therefrom, can be determined with the method set forth in standard EN 933-11:2009. The amount of hazardous materials and impurities, as well as the material distribution, in cleaned surplus concrete or concrete waste, or in demolition concrete obtained therefrom, especially in cleaned crushed concrete, can likewise be determined with the methods set forth in said standards.

The removal/reducing the amount of hazardous materials from surplus concrete or concrete waste can be performed by analyzing the foreign substances and hazardous materials present in a concrete structure made up of surplus concrete/concrete waste, or in demolition concrete obtained from such a concrete structure, followed by separating/sorting out from the concrete structures of surplus concrete or concrete waste, or from demolition concrete obtained therefrom, the concrete fractions containing foreign substances and/or hazardous materials, prior to fine crushing the surplus concrete or concrete waste, or the demolition concrete obtained therefrom, into crushed concrete.

Alternatively, in case it is known about a concrete structure of surplus concrete or concrete waste on the basis of its origin, or it is known about demolition concrete obtained from surplus concrete or concrete waste on the basis of its demolition site or origin or the like, that it does not contain hazardous materials at least in such quantities that would cause problems regarding the use of concrete, such a demolition concrete, a surplus concrete structure, or a concrete waste structure can be crushed directly into cleaned crushed concrete.

The structural target strength of concrete products, concrete waste surplus concrete refers in this application to structural compressive strength.

Reclaimed aggregate refers to aggregate, which is produced from an inorganic material that has served as a building material and which mainly comprises crushed, cleaned and screened concrete, and which is further about to be used as aggregate in the production of concrete (BY 43: 2008).

In one embodiment, the quality of reclaimed aggregate fulfills the requirements of European product standard SFS EN 12620 +A1:2008.

In another embodiment, the reclaimed aggregate fulfills the requirements of National application standard SFS 7003:2022.

Other aggregate refers here to an aggregate, which is used for the production of concrete and which is other than the reclaimed aggregate. The other aggregate may consist of artificial aggregate or natural aggregate, such as crushed stone, sand, etc., which are used in this industry for the production of concrete and, in this respect, reference is indeed made to technology prior known in this sector.

The cleaned crushed concrete refers to coarse crushed concrete, which is obtained from a structure made up of surplus concrete or concrete waste and from which have been removed at least the hazardous materials cited in claim 1 or 2, and which coarse crushed concrete has been further crushed, if necessary, into finer, cleaned crushed concrete.

The cleaned crushed concrete stands also for coarse crushed concrete, which is made up of demolition concrete and from which have been removed at least the hazardous materials cited in claim 1 or 2, and which coarse crushed concrete has been further crushed, if necessary, into finer crushed concrete.

The strength class requirement of recyclable concrete waste or surplus concrete is fulfilled for example by subjecting a recyclable concrete structure made up of surplus concrete or concrete waste, or demolition concrete obtained therefrom, to a strength class test according to standard SFS EN 12390-3:2019 or the like.

The unit employed for concrete strength is megapascal (1 MPa=1 N/mm²) and the compressive strength of concrete is influenced, among other things, by the water cement ratio in concrete production recipe, by the quality and quantity cement, by the aggregate and its granularity, by mix ingredients and admixtures, by the age of cured concrete, etc.

The sampling is generally conducted by taking a test sample from a concrete structure of surplus concrete or concrete waste either with a diamond drill, such as a chuck drill, or by chipping. The test sample is generally cubical, cylindrical, or a core sample extracted from inside the concrete structure.

The sampling should be carried out as defined in standards EN-12350-1:2019, EN 12390-1:2021, EN 12390-2:2019. Likewise, other methods known in the art can be used for determining the structural strength of those concrete structures from which the concrete waste originates.

Alternatively, the classification of concrete waste or surplus concrete can be conducted by using strength-indicating documents such as structure type drawings. In the event that a concrete structure of concrete waste or surplus concrete is originally designed, for example, to be included in strength class (compressive strength) or 2, it can often be considered confidently that the demolition concrete (crushed concrete as well as concrete blocks), obtained from the discussed concrete structure (concrete waste or surplus concrete), also fulfills the structural target strength of not less than 45 N/mm² (class 1) or not more than 45 N/mm², yet more than 30 N/mm² (class 2).

The compressive strength for demolition concrete obtained from surplus concrete or concrete waste, for crushed concrete or concrete blocks made up of demolition concrete, as well as for cleaned crushed concrete, can also be determined directly with the method according to standard Pank 9003 F1 or the like. Even though the standard Pank 9003 FI is primarily intended for earth construction or green construction purposes for the classification of crushed concrete along the lines of standard SFS 5884, the method described in said standard can also be used for assessing the compressive strength of cleaned crushed concrete in the present method.

According to standard Pank 9003 FI, the crushed concrete to be tested is not allowed to contain more than 10% of brick and tile waste and 1% of other impurities. Thus, from 7 as well as 28 days old crushed concrete are extracted test specimens in the size of at least 100 mm. After all, in the present wet concrete production method, the brick and tile waste contained in cleaned crushed concrete, as well as other impurities (foreign substances), are subjected to limits that are considerably lower than those presented in standard Pank 9003 FI.

Foreign substances refer here to non-floating matter (X), not included in a concrete structure and in crushed concrete obtained therefrom, such as non-floating clay and other cohesive soil and earth, miscellaneous metals, wood, rubber, plastic, glass, gypsum plaster, etc. (Government Decree 446/2022 as well as EU directive 2008/87/EC).

Foreign substances further refer here to floating particles (FL), not included in crushed concrete, i.e. floating impurities (Government Decree 466/2022 as well as EU directive 2008/87/EC). The floating impurities (floating particles) consist of material not included in crushed concrete and capable of floating in water (material lighter than water), such as plastics and insulation materials.

Foreign substance further refers to brick and tile waste, such as bricks and clinkers, sand lime bricks and blocks, as well as other burnt bricks, and also non-floating foamed concrete (Rb).

In terms of material, the foreign substances present in concrete structures are typically microbes, wood, plastic, brick, tile, asbestos, glass, gypsum board, etc.

The cleaned crushed concrete is allowed to contain foreign substances as follows:

The portion of floating particles (FL) comprising a foreign substance is not more than 5 cm³/kg of crushed concrete, such as 0-5 cm³/kg of crushed concrete, preferably 0 cm³/kg of crushed concrete, and the portion of non-floating matter comprising a foreign substance in crushed concrete is less than 1% by weight, such as 0-1% by weight, the portion of brick and tile waste (Rb) in crushed concrete is less than 30% by weight, preferably less than 10% by weight, such as 0-10% by weight, especially 0-2 p-%, especially favorably 0% by weight.

The foreign substances can be removed from surplus concrete or concrete waste, or from demolition concrete produced therefrom, such as from crushed concrete, by first analyzing the type and amount of foreign substances in concrete waste or surplus concrete and by then separating the contaminated concrete waste or surplus concrete containing foreign substances, or the demolition concrete obtained therefrom, from the cleaner concrete material or demolition concrete. The amount of foreign substances can be reduced from a structure by using light demolition.

Light demolition is a voluntary process conducted on a structure to be demolished or renovated. An appraisal visit involves reviewing the movable property, furniture and other light structural components such as lighting, wet area fixtures and room dividers.

Alternatively, it is from demolition concrete, such as crushed concrete, produced from surplus concrete or concrete waste, that foreign substances are separated magnetically (metals), by airflow separation or by some other separation method based on dissimilar specific weights of objects and crushed stone obtained therefrom. Airflow separation must generally be preceded by crushing the demolition concrete into crushed concrete. The foreign substances can also be removed from crushed concrete by screening or some other separation method based on the shape or surface area of foreign substances.

The demolition of concrete structures and the removal of foreign substances can also be carried out by using methods known from the prior art, such as, among others, EP application 2949632 and Chinese published application CN113277772.

In terms of a more detailed execution of the removal of foreign substances (microbes, dust, dirt, rebar steel, wood, asbestos, plastic, etc.), reference is also made to practices and methods known in the art. The analysis of foreign substances from surplus concrete or concrete waste, or from crushed concrete obtained therefrom, can also be carried out by using the method presented in standard EN 933-11:2009. This particular method comprises a method for clarifying the constitution of a coarse material and is therefore applicable to identifying the relative proportions of foreign substances and concrete/crushed concrete.

A prior known process, among others, is the removal of impurities and microbial contaminants from concrete waste or crushed concrete by means of water-wash, the removal of ferromagnetic compounds (e.g. reinforcing steel) by water-wash, magnetically, the sorting of materials based on dissimilar specific weights thereof (centrifugation, cyclone), the sorting of particles based on the size and specific surface area of particles.

The filler employed in the fabrication of structural interior components is aggregate which contains finely divided sand and possibly finely divided crushed stone, as well as recycled (reused) crushed concrete, which has been fine crushed and screened to a particle size of at least 16-32 mm and/or 8-16 mm.

In the fabrication of structural exterior components, it is possible to make use of finely crushed and screened crushed concrete whose particle size is more than 32 mm, or crushed concrete whose particle size is within the range of 16-32 mm, 8-16 mm or 0-8 mm.

Structural exterior components made of concrete are used, among others, in house foundation concrete, underwater concrete, railway cable duct, outdoor tiles or edging stones, noise barrier or retaining wall, and erosion control tile.

Structural interior components made of concrete are used in house or hall foundations, indoor stairs, balcony, or outdoor stairs. Such concrete has high strength requirements, as well as high requirements also in terms of foreign substances and hazardous materials.

In some embodiments, the wet concrete is also supplemented with other screened aggregate, which is produced from natural stone material, such as sand, crushed stone, gravel, or from artificial stone material, and which is included in sieve class C3 and/or C4 and has a particle size within the range of 0-8 mm and/or 8-16 mm.

In some embodiments, the wet concrete is supplemented with biocoal 1-10% by weight of the wet concrete's dry weight. The addition of biocoal into wet concrete may enhance the compressive strength of the produced concrete. It is by the addition of biocoal that the proportion of cement used for concrete can be respectively diminished, thereby reducing the utilization rate of virgin materials in concrete. It is also be the use of biocoal that the climate effects of concrete can be mitigated.

In some embodiments, the biocoal has been produced by torrefying biomass, such as wood, in oxygen-free conditions, at a temperature of about 300-800° C. (slow pyrolysis).

The invention provides significant benefits, the reuse of crushed concrete in the production of wet concrete enabling the production of structural interior and exterior components, whereby crushed concrete need no longer be utilized solely in earth construction. The use of a method, wet concrete, and/or an apparatus according to the invention makes it possible that a new building or components, such as the walls of a structure, used in construction, leave a carbon handprint which is considerably smaller than the carbon handprint of buildings, components or walls constructed with traditional methods. The invention expedites the execution time of construction projects. Thus, the invention enhances circular economy in construction sector.

The use of crushed concrete in the production of wet concrete also reduces the carbon dioxide emissions of concrete grades made from such wet concrete; the concrete grades manufactured this way are classified as low carbon and the BY Low-carbon classification thereof is typically GWP.85% relative to the relative emission rate of this particular concrete grade.

When calculating the carbon dioxide emissions of a concrete grade, attention is paid, among others, to the type and amount of raw materials contained in the concrete recipe, as well as to the mode and distance of transporting the raw materials, and to the electrical and heating energy used in the production of concrete.

The most important factors in a concrete recipe with an effect on carbon dioxide emissions are the type and amount of cement and aggregate. The effect of admixtures on the carbon dioxide emission rate is generally relatively modest as the amounts thereof in the concrete recipe are small. For example, the mission rates of cements are typically within the range of 0.470-1.100 kg CO₂e/(kg) and those of aggregate are 0.004-0.006 CO₂e/(kg), depending e.g. on the quality and particle size of the aggregate. For sand, among others, the emission rate is 0.004 kg CO₂e/kg and for crushed stone 0.006 CO₂e/kg.

The emission rate of reused crushed concrete is low or even negative. In the production of wet concrete, the proportion of cement in emission rates is about 40-60% and the proportion of aggregate in emission rates is about 1% (the rest of emission rates consisting of e.g. other ingredients, water, transports, and the like), since the reused crushed concrete reduces emission rates of concrete by about 0.3-0.7%.

The invention will be described in more detail with working examples A and 1-3.

### EXAMPLE A

An example of the removal of foreign substances by grading from a concrete structure made up of concrete waste.

Referring particularly to structures consisting of concrete waste, the foreign substances can be removed, prior to the demolition of concrete waste, as follows: the building is subjected to a material review as well as to a so-called material analysis (in addition to an asbestos and contaminant survey). The Ministry of the Environment has on Nov. 15, 2019 published a demolition survey guide (Demolition survey—Guide for the author), which provides information about best practices as regards the evaluation, i.e. the demolition survey, to be conducted prior to the demolition or renovation of a building or structure relating to the flows of construction and demolition waste.

The grading of foreign substances depends on the quality of a concrete structure made up of concrete waste, the building's interior often housing, mixed within concrete, e.g. gypsum, wood, plastic, glass, tiles as well as ceramics, metal, fixtures, stone wool and other insulators. On the other hand, the demolition of a concrete structure used as a building's frame material often involves the presence of bricks, wood waste, metal waste, miscellaneous construction waste, roofing felt, wool and plastics.

It is at the demolition site of a structure comprising concrete waste that the following fractions are sorted to separate them from each other:
fractions with a content of asbestos and other contaminant-containing wastes, these fractions being removed as set forth in the asbestos and contaminant report (AHA survey report)
foreign substance-containing fractions contained in concrete waste or surplus concrete, or in crushed concrete obtained therefrom: solid non-floating impurities (X), i.e. non-floating matter, and floating impurities (FL), i.e. floating particles, are separated from clean concrete material
fractions, comprising impurities (X) not capable of floating in water. These include, among others, cohesive soil, miscellaneous metals, non-floating wood, plastic, rubber and gypsum plaster, insulation materials, glass
fractions, comprising impurities (particles) capable of floating in water. The floating impurities (FL) include, among others, wool, floating wood material.

Alternatively or in addition, some of the foreign substances can be removed after the concrete structure has been demolished into coarse crushed concrete. The foreign substances can be removed from crushed concrete e.g. with water-wash (microbes and other light material) or with methods based on airflow or dissimilar specific surface areas of materials.

Reusable equipment and furniture, metals, clean concrete, wood, roofing felt, miscellaneous construction waste will be salvaged.

Hazardous wastes (e.g. impregnated wood, oils, contaminated concrete, etc.) will be discarded.

### EXAMPLE 1

### Production of Foundation Concrete

| ″Footing concrete | 1 | m³ |
|---|---|---|
| Weight of ingredient in footing concrete (1 m³) | | |
| Cement (Plus) | 430 | kg/m³ |
| Sand, particle size 0-2 mm | 100 | kg/m³ |
| Sand, particle size 0-8 mm | 1050 | kg/m³ |
| Crushed concrete, particle size 5-16 mm | 566 kg/m³ (moist) | |
| Water | 210 | kg/m³ |
| Plasticizer | 1.7 | kg/m³ |

The crushed concrete, wet concrete, used in example 1, consists of footing concrete, i.e. wet concrete, suitable for the fabrication of structural exterior components. As reclaimed aggregate there can be used strength-graded, finely crushed and screened crushed concrete whose particle size is included in one of the sieve classes C1-C4. The wet concrete's reclaimed aggregate, i.e. crushed concrete, is included in one of the strength classes 1, 2 or 3.

The employed crushed concrete consists of cleaned crushed concrete, which has been produced from crushed concrete by removing asbestos, hazardous materials, as well as foreign substances from the crushed concrete in such a way that the proportion of floating particles (FL) in clean crushed concrete is 0 cm³/kg of crushed concrete, the non-floating matter, comprising a foreign substance, makes up less than 1% by weight of the crushed concrete, the proportion of brick and tiles wastes (Rb) is less than 30% by weight, and the amount of hazardous materials, especially polychlorinated phenyls, is not more than 1 mg/kg, the amount of polyaromatic hydrocarbons is not more than 30 mg/kg, and the amount of mineral oils (C₁₀-C₄₀) is not more than 200 mg/kg;

In the wet concrete produced in example 1, some of the aggregate was replaced with recycled crushed concrete (30%). Since the emission rate of recycled crushed concrete is zero or even negative, the carbon dioxide emission rates were reduced by about 5% in comparison with the situation in which all aggregate would be virgin. The produced concrete cubes are hence classified as low carbon and have a BY Low-carbon classification of about GWP.85%.

### EXAMPLE 2

### Production of BIOcoal-Extended Concrete

| ″Footing concrete | 1 | m³ |
|---|---|---|
| Weight of ingredient in footing concrete (1 m³) | | |
| Cement (Plus) | 430 | kg/m³ |
| Sand, particle size 0-2 mm | 100 | kg/m³ |
| Sand, particle size 0-8 mm | 1050 | kg/m³ |
| Crushed concrete, particle size 5-16 mm | 566 kg/m³ (moist) | |
| Water | 210 | kg/m³ |
| Plasticizer | 1.7 | kg/m³ |

As for cement, 5-10% thereof can be replaced with biocoal. Biocoal provides concrete with enhanced ability to protect structures at utilization sites from electromagnetic radiation and improves the strength characteristics of concrete.

### EXAMPLE 3

The processing of demolition concrete into crushed concrete suitable for the fabrication of structural interior or exterior components (general instruction):

The quality of concrete waste can be influenced first and foremost by demolition technique. The meaning of sorting demolition has a highly significant role with regard to the quality of concrete waste. In addition, the correct type of processing/crushing technique has a major impact on the quality of an end product.

The demolition was preceded by subjecting the building to a material review, as well as to a so-called material analysis, and also to an asbestos and contaminant survey.

From demolition concrete are separated asbestos and other hazardous materials in accordance with a so-called asbestos and contaminant survey report (AHA survey report).

Thereafter, the reuse-qualified demolition concrete waste was classified as follows:

### Class 1—High-Strength Concrete Waste

The first class (class 1) includes concrete waste, in which the original compressive strength of structure test specimens has been more than 45 N/mm² or wherein, on the basis of design documents, the demolition concrete can be reliably classified for this class. The reclaimed aggregates included in class 1 can be used in recycled concrete whose target strength is not more than 45 N/mm².

The second class (class 2) includes concrete waste of conventional strength grade, in which the original compressive strength of structure test specimens has been within the range of 30-45 N/mm² or wherein, on the basis of design documents, the demolition concrete can be reliably classified for this class. The reclaimed aggregates included in class 2 can be used in C-class recycled concrete whose target strength is not more than 30 N/mm².

The third class (class 3) includes concrete waste, in which the original compressive strength of structure test specimens has been less than 30 N/mm² or wherein, on the basis of design documents, the demolition concrete can be classified for this class. The reclaimed aggregates included in class 3 can be used in recycled concrete which has no target strength.

The wet concrete suitable for the fabrication of structural exterior components is produced from demolition concrete, which is included either in first, second or third strength class.

The wet concrete suitable for the fabrication of structural interior components is, on the other hand, produced from demolition concrete, which is included either in first or in second strength class.

Depending on national or regional contaminant standards, from the concrete waste are further removed, if necessary, heavy metals and metalloids. The European Parliament and Council Directive 2008/98/EC, regarding wastes, determines acceptable limit values for hazardous materials, such as for heavy metals, non-metals and metalloids. In Finland, the limit values consistent with Directive 2008/98/EC have been determined in Government Decree 466/2022, relating to evaluation criteria for terminating the classification of crushed concrete as waste. The limit values for the solubility of heavy metals and metalloids in cleaned crushed concrete are (mg/kg): antimony (Sb) 0.2, arsenic (As) 0.1, barium (Ba) 5, cadmium (Cd) 0.02, chromium (Cr) 0.6, copper (Cu) 1, mercury (Hg) 0.01, lead (Pb) 0.1, molybdenum (Mo) 0.7, nickel (Ni) 0.3, vanadium (V) 0.3, zinc (Zn) 4, selenium (Se) 0.2, fluoride (F⁻) 12, sulfate (SO₄²⁻), 300 and chloride (Cl⁻) 200.

It is from concrete waste, applicable to the fabrication of structural interior components and included in first or second strength class, that cleaned crushed concrete is produced by removing, if necessary, asbestos, hazardous materials, as well as foreign substances from crushed concrete waste in such a way that the proportion of floating particles (FL) in crushed concrete is not more than 5 cm³/kg of crushed concrete, such as 0-5 cm³/kg of crushed concrete, preferably 0 cm³/kg of crushed concrete, the content of non-floating matter, comprising a foreign substance, in crushed concrete is less than 1% by weight, the proportion of brick and tile waste (Rb) in crushed concrete is less than 30% by weight, and the amount of hazardous materials, especially polychlorinated phenyls, is not more than 1 mg/kg, the amount of polyaromatic hydrocarbons is not more than 30 mg/kg, and the amount of mineral oils (C₁₀-C₄₀) is not more than 200 mg/kg.

Thereafter, the cleaned crushed concrete is crushed and screened to a desired particle size.

Crushed concrete is crushed and screened to a desired particle size either with
a) a screen-equipped mobile crusher, which is capable screening a batch of crushed concrete into several fractions, or b) with a pulverizing device or an excavator which is equipped with a flat screen.

It is from concrete waste, applicable to the fabrication of structural exterior components and included in first, second or third strength class, that cleaned crushed concrete is produced by removing, if necessary, asbestos, hazardous materials, as well as foreign substances from crushed concrete waste in such a way that the proportion of floating particles (FL) in crushed concrete is 0 cm³/kg of crushed concrete, the content of non-floating matter, comprising a foreign substance, in crushed concrete is less than 1% by weight, the proportion of brick and tile wastes (Rb) in crushed concrete is less than 30% by weight, and the amount of hazardous materials, especially polychlorinated phenyls, is not more than 1 mg/kg, the amount of polyaromatic hydrocarbons is not more than 30 mg/kg, and the amount of mineral oils (C₁₀-C₄₀) is not more than 200 mg/kg.

Thereafter, the cleaned crushed concrete is crushed and screened to a desired particle size.

Crushed concrete is crushed and screened to a desired particle size either with
a) a screen-equipped mobile crusher, which is capable screening a batch of crushed concrete into several fractions, or b) with a pulverizing device or an excavator which is equipped with a flat screen.

The finely crushed concrete is screened with a sieving device for producing clean, strength-graded, finely crushed and screened crushed concrete, which is included in one of the sieve classes C1-C4:
class C1, cleaned, strength-graded, finely crushed and screened crushed concrete, particle size more than 32 mm,
class C2, cleaned, strength-graded, finely crushed and screened crushed concrete, particle size 16-32 mm,
class C3, cleaned, strength-graded, finely crushed and screened crushed concrete, particle size 8-16 mm,
class C4, cleaned, strength-graded, finely crushed and screened crushed concrete, particle size 0-8 mm;

The reclaimed aggregate, used in wet concrete applicable to the fabrication of structural exterior components, can be strength-graded, finely crushed and screened crushed concrete, which is included in one of the sieve classes C1-C4.

Such wet concrete suitable for the fabrication of structural exterior components can be used, among others, in earth constructions: underwater concrete, railway cable ducts, tiles, edging stones, etc. in noise barriers, retaining walls, and erosion control tiles.

The reclaimed aggregate, used in wet concrete applicable to the fabrication of structural interior components, can be strength-graded, finely crushed and screened crushed concrete, which is included in one of the classes C2 or C3.

Such wet concrete suitable for the fabrication of structural interior components can be used as foundation concrete for houses, in hall foundations and indoor stairs. It can also be used, among others, for balconies, outdoor stairs and foundations.

1. A method for for the production of wet concrete applicable to the fabrication of structural exterior components, by mixing a binder, especially cement, a filler, comprising reclaimed aggregate, and water, as well as possible admixtures, such as a plasticizer, in such a way that from the dry matter of wet concrete the portion of a binder, especially cement, is 10-40% by weight, preferably 25-30% by weight, the portion of a filler, especially aggregate, is 90-60% by weight, the total amount of filler (i.e. aggregate) being nevertheless not more than 80% by weight of the wet concrete's total weight, and said aggregate comprising reclaimed aggregate, especially cleaned crushed concrete, 10-100% by weight, preferably 30-60% by weight, and other aggregate, such as sand or crushed stone, 90-0% by weight, preferably 70-40% by weight, characterized in that the production of reclaimed aggregate, especially cleaned crushed concrete, comprises the following method steps A-D of.
A) producing cleaned crushed concrete by removing from a concrete structure made up of surplus concrete or concrete waste, or from demolition concrete, especially coarse crushed concrete, obtained therefrom, hazardous materials as well as foreign substances in such a way that the presence of foreign substances and/or hazardous materials in the cleaned crushed concrete is such that, as for foreign substances, the portion of floating particles (FL) is not more than 5 cm³/kg of crushed concrete, such as 0-5 cm³/kg of crushed concrete, preferably 0 cm³/kg of crushed concrete, the content of non-floating material, comprising foreign matter, in the crushed concrete is not more than 1% by weight, such as 0-1% by weight, especially 0% by weight, and the amount of brick and tile waste (Rb), comprising foreign matter, is less than 30% by weight, preferably less than 10% by weight, such as 0-10% by weight, especially 0-2% by weight, particularly favorably 0% by weight, and the amount of hazardous materials per kg of cleaned crushed concrete is as follows: the amount of polychlorinated phenyls is not more than 1 mg/kg, the amount of polyaromatic hydrocarbons is not more than 30 mg/kg, and the amount of mineral oils (C₁₀-C₄₀) is not more than 200 mg/kg;
B) evaluating or determining a target strength for cleaned crushed concrete into one of the classes (1-3) in order to produce cleaned and strength-graded crushed concrete:
strength class 1, cleaned crushed concrete, structural target strength not more than 45 N/mm²,
strength class 2, cleaned crushed concrete, structural target strength not more than 45 N/mm², yet more than 30 N/mm²,
strength class 3, cleaned crushed concrete, no structural target strength;
C) crushing the cleaned and strength-graded crushed concrete into finer particles with a crushing device, followed by screening the finely crushed concrete with a sieving device for producing cleaned, finely crushed and screened crushed concrete, which is included in one of the sieve classes C1-C4;
class C1, cleaned, strength-graded, finely crushed and screened crushed concrete, particle size more than 32 mm,
class C2, cleaned, strength-graded, finely crushed and screened crushed concrete, particle size 16-32 mm,
class C3, cleaned, strength-graded, finely crushed and screened crushed concrete, particle size 8-16 mm,
class C4, cleaned, strength-graded, finely crushed and screened crushed concrete, particle size 0-8 mm;
D) selecting, for reclaimed aggregate in wet concrete, cleaned, strength-graded, finely crushed and screened crushed concrete, comprising crushed concrete in strength class 1, 2 or 3 and having a particle size in one of the classes C1-C4.

2. A method for the production of wet concrete applicable to the fabrication of structural interior components, by mixing a binder, especially cement, a filler, comprising reclaimed aggregate, and water, as well as possible admixtures, such as a plasticizer, in such a way that from the dry matter of wet concrete the portion of a binder, especially cement, is 10-40% by weight, preferably 25-30% by weight, the portion of a filler, especially aggregate, is 90-60% by weight, the total amount of filler (i.e. aggregate) being nevertheless not more than 80% by weight of the wet concrete's total weight, and said aggregate comprising reclaimed aggregate, especially cleaned crushed concrete, 10-100% by weight, preferably 30-60% by weight, and other aggregate, such as sand or crushed stone, 90-0% by weight, preferably 70-40% by weight, characterized in that the production of reclaimed aggregate comprises method steps A-D of:
A) producing cleaned crushed concrete by removing from a concrete structure made up of surplus concrete or concrete waste, or from demolition concrete, especially coarse crushed concrete, obtained from a concrete structure, hazardous materials as well as foreign substances and, if necessary, by crushing a concrete structure or demolition concrete obtained therefrom into finer crushed concrete in such a way that the cleaned crushed concrete has foreign substances and/or hazardous materials present therein and, as for said foreign substances, the portion of floating particles (FL) is not more than 5 cm³/kg of crushed concrete, such as 0-5 cm³/kg of crushed concrete, preferably 0 cm³/kg of crushed concrete, the content of non-floating material, comprising foreign matter, in the crushed concrete is not more than 1% by weight, such as 0-1% by weight, especially 0% by weight, and the portion of brick and tile waste (Rb), included in foreign substances, is less than 30% by weight, preferably less than 10% by weight, such as 0-10% by weight, especially 0-2% by weight, particularly favorably 0% by weight, and the amount of hazardous materials, particularly polychlorinated phenyls, is not more than 1 mg/kg of crushed concrete, the amount of polyaromatic hydrocarbons is not more than 30 mg/kg of crushed concrete, and the amount of mineral oils (C₁₀-C₄₀) is not more than 200 mg/kg of crushed concrete,
B) evaluating or determining a target strength (compressive strength) for cleaned crushed concrete into one of the classes (1-3) in order to produce clean and strength-graded crushed concrete:
strength class 1, crushed concrete, structural target strength not more than 45 N/mm²,
strength class 2, crushed concrete, structural target strength not more than 45 N/mm², yet more than 30 N/mm²,
strength class 3, crushed concrete, no structural target strength;
C) crushing the cleaned and strength-graded crushed concrete, if necessary, into finer particles with a crushing device, followed by screening the finely crushed concrete with a sieving device for producing clean, finely crushed and screened crushed concrete, which is included in one of the sieve classes C1-C4;
class C1, cleaned, strength-graded, finely crushed and screened crushed concrete, particle size more than 32 mm,
class C2, cleaned, strength-graded, finely crushed and screened crushed concrete, particle size 16-32 mm,
class C3, cleaned, strength-graded, finely crushed and screened crushed concrete, particle size 8-16 mm,
class C4, cleaned, strength-graded, finely crushed and screened crushed concrete, particle size 0-8 mm;
D) selecting, for reclaimed aggregate in wet concrete, cleaned, strength-graded, finely crushed and screened crushed concrete, comprising crushed concrete in strength class 1 or 2 and having a particle size in class C2 or C3.

3. A method according to claim 1 or 2, characterized in that cleaned crushed concrete is produced by further removing, in step A, non-metallic hazardous materials from surplus concrete or concrete waste in such a way that the cleaned crushed concrete contains, per kilogram of crushed concrete, soluble fluorides (F) not more than 12 mg/kg, sulfates (SO₄²⁻) not more than 300 mg/kg, and chlorides (Cl) not more than 200 mg/kg.

4. A method according to claim 1 or 2, characterized in that the produced wet concrete contains one or more hazardous materials from group 1 or 2
1) an organic hazardous material, selected from a group (concentration limits for each hazardous material presented as total content), including: polychlorinated phenyls 0.01-1 mg/kg, polyaromatic hydrocarbons 0.1-30 mg/kg, and mineral oils (C₁₀-C₄₀) (1-200 mg/kg), or
2) metallic or non-metallic hazardous materials, selected from a group (the content of a hazardous material presented as soluble concentration), including fluorides (F) 1-12 mg/kg, sulfates (SO₄²⁻) 1-300 mg/kg, and chlorides (Cl) 1-200 mg/kg.

5. A method according to claim 1 or 2, characterized in that the cleaned crushed concrete contains one or more non-metallic, metalloidic or metallic hazardous materials per kilogram of crushed concrete (determined as the amount of hazardous material per kilogram of crushed concrete), selected from a group, including antimony (Sb) 0.001-0.2 mg/kg, arsenic (As) 0.001-0.1 mg/kg, barium (Ba) −0.01-5 mg/kg, cadmium (Cd) 0.0001-0.02 mg/kg, chromium (Cr) 0.001-0.6 mg/kg, copper (Cu) 0.01-1 mg/kg, mercury (Hg) 0.0001-0.01 mg/kg, lead (Pb) 0.001-0.1 mg/kg, molybdenum (Mo) 0.001-0.7 mg/kg, nickel (Ni) 0.001-0.3 mg/kg, vanadium (V) 0.001-0.3 mg/kg, zinc (Zn) 0.01-4 mg/kg, selenium (Se) 0.001-0.2 mg/kg, fluorides (F⁻) 0.01-12 mg/kg, sulfates (SO₄²⁻) 1-300 mg/kg, and chlorides (Cl⁻) 1-200 mg/kg.

6. A method according to claim 1 or 2, characterized in that the limit values of heavy metals, non-metals, and metalloids in wet concrete, intended for the fabrication of both structural exterior components and structural interior components and produced as presented in claim 1 or 2, stay below the value (mg/kg of soluble hazardous material): antimony (Sb) 0.2, arsenic (As) 0.1, barium (Ba) 5, cadmium (Cd) 0.02, chromium (Cr) 0.6, copper (Cu) 1, mercury (Hg) 0.01, lead (Pb) 0.1, molybdenum (Mo) 0.7, nickel (Ni) 0.3, vanadium (V) 0.3, zinc (Zn) 4, selenium (Se) 0.2, fluoride (F⁻) 12, sulfate (SO₄²⁻) 300 and chloride (Cl⁻) 200.

7. A method according to claim 1 or 2, characterized in that the removal of foreign substances from concrete structures is performed either
a) by sorting the concrete structures, containing said foreign substances and made up of surplus concrete or concrete waste, to separate the same from clean concrete structures, and by crushing the thus obtained clean concrete structures into crushed concrete, or
b) by removing the foreign substances from demolition concrete, especially from coarse crushed concrete, obtained from said concrete structure consisting of surplus concrete or concrete waste, by means of a method based on the different specific weights or specific surfaces areas of foreign substances and concrete, and by then crushing the demolition concrete, especially the coarse crushed concrete, into finer crushed concrete.

8. A method according to any of the preceding claims, characterized in that the quality of reclaimed aggregate used in the production of wet concrete fulfills the requirements of European product standard SFS EN 12620+A1: 2008 and/or the requirements of National application standard SFS 7003:2022.

9. A method according to claim 1 or 2, characterized in that the wet concrete is also supplemented with other aggregate, which is produced from natural stone, sand, or gravel, and which is included in one of the sieve classes C1-C4:
class C1, screened aggregate, particle size more than 32 mm
class C2, screened aggregate, particle size 16-32 mm
class C3, screened aggregate, particle size 8-16 mm
class C4, screened aggregate, particle size 0-8 mm.

10. A method according to claim 1 or 2, characterized in that the wet concrete's binder, especially cement, has not more than 5% by weight or not more than 10% by weight, such as 1-5% by weight or 1-10% by weight thereof replaced with biocoal.

11. A method according to claim 1 or 2 or 10, characterized in that into the wet concrete is added biocoal 1-3% by weight, calculated from the wet concrete's dry weight.

12. A method according to claim 10 or 11, characterized in that the biocoal has been produced by torrefying biomass, such as wood, in oxygen-free conditions, at high temperature (slow pyrolysis), especially at a temperature of 300-800° C.

13. A method according to claim 1 or 2, characterized in that the aggregate used for the production of wet concrete has 10-100% by weight, preferably 30-50% by weight, thereof made up of recycled crushed concrete, which reduces the aggregate's carbon dioxide emission rate respectively by 10-100%, preferably by 30-50%.

14. A method according to claim 1 or 2, characterized in that the production of wet concrete is carried out by using cement 18-30% by weight, sand in particle size 0-8 mm and/or crushed stone in particle size 8-16 mm, totaling 50-30% by weight, recycled crushed concrete in particle size 8-16 mm 30-50% by weight, water 8-15% by weight, and possibly concrete production admixtures, such as a plasticizer, a hardening accelerator, a hardening retarder, a microbicide, a water absorption inhibitor, a concrete antifreeze, 0.5-2.5% by weight.

15. A method for the fabrication of a structural interior or exterior component
by providing wet concrete produced with a method as set forth in claim 1 or 2,
by then casting the wet concrete into a mold, which prior to casting is fitted with reinforcing bars and possible brackets,
by allowing the concrete to dry in the mold,
once the concrete has cured, by disassembling the mold.

16. An apparatus for executing a wet concrete production method as set forth in claim 1 or 2, characterized in that the apparatus comprises a concrete station as well as, in association with the concrete station, either
a) a mobile crusher equipped with a screening sieve or
b) a pulverizing device or an excavator equipped with a flat screen
for crushing demolition concrete into crushed concrete and for screening the same to desired particle size/sizes.

17. Wet concrete for the fabrication of structural interior components with a method as set forth in claim 1, by mixing cement 10-40% by weight, preferably 25-30% by weight, a filler, especially aggregate which contains reclaimed aggregate 90-60% by weight, water, as well as possible admixtures, such as a plasticizer, whereby, regarding the dry matter of wet concrete, the total amount of filler (i.e. aggregate) is not more than 80% by weight of the wet concrete's total weight, and said aggregate comprising reclaimed aggregate, especially cleaned crushed concrete, 10-100% by weight, preferably 30-60% by weight, and other aggregate, such as artificial aggregate or natural aggregate, especially sand or crushed stone, 90-0% by weight, preferably 50-70% by weight, characterized in that, for the wet concrete's reclaimed aggregate, has been selected crushed concrete which has been cleaned, strength-graded, finely crushed and screened as defined in claim 2 and which comprises crushed concrete in strength class 1 or 2 with a particle size that is included in class C3 or C4, preferably in class C4, and further characterized in that the cleaned crushed concrete contains, per kilogram of crushed concrete,
A) one or more organic hazardous materials, selected from a group (concentration limits for hazardous material presented as total content), including: polychlorinated phenyls 0.01-1 mg/kg, polyaromatic hydrocarbons 1-30 mg/kg, and mineral oils (C₁₀-C₄₀) 1-200 mg/kg, and/or
B) metallic or non-metallic hazardous materials, selected from a group (the content of hazardous material presented as soluble concentration), including fluorides (F⁻) 1-12 mg/kg, sulfates (SO₄²⁻) 1-300 mg/kg and chlorides (Cl⁻) 1-200 mg/kg.

18. Wet concrete according to claim 17, characterized in that production of wet concrete is carried out by using cement 18-30% by weight, as well as sand in particle size 0-8 mm and/or crushed stone in particle size 8-16 mm, totaling 50-30% by weight, cleaned crushed concrete, derived from a demolished concrete structure, whose particle size is 8-16 mm, totaling 30-50% by weight, water 8-15% by weight, and possibly concrete production admixtures, such as a plasticizer, a hardening accelerator, or a water absorption inhibitor, 0.5-2.5% by weight.

19. Wet concrete according to claim 17 or 18, characterized in that the cleaned crushed concrete contains one or more non-metallic, metalloidic or metallic hazardous materials, per kilogram of crushed concrete (determined as a soluble amount of hazardous material per kilogram of crushed concrete), selected from a group, including: antimony (Sb) 0.001-0.2 mg/kg, arsenic (As) 0.001-0.1 mg/kg, barium (Ba) −0.01-5 mg/kg, cadmium (Cd) 0.0001-0.02 mg/kg, chromium (Cr) 0.001-0.6 mg/kg, copper (Cu) 0.01-1 mg/kg, mercury (Hg) 0.0001-0.01 mg/kg, lead (Pb) 0.001-0.1 mg/kg, molybdenum (Mo) 0.001-0.7 mg/kg, nickel (Ni) 0.001-0.3 mg/kg, vanadium (V) 0.001-0.3 mg/kg, zinc (Zn) 0.01-4 mg/kg, selenium (Se) 0.001-0.2 mg/kg, fluoride (F⁻) 1-12 mg/kg, sulfate (SO₄²⁻) 1-300 mg/kg, and chloride (Cl) 1-200 mg/kg.

20. The use of wet concrete according to claim 17 in the foundations, indoor stairs, balcony or outdoor stairs of a house or a hall.

21. The use of wet concrete, produced with a method according to claim 1, in a house's foundation concrete, underwater concrete, railway cable duct, outdoor tiles, edging stones, noise barrier, retaining wall or erosion control tile.
